(19) United States
(12) Patent Application Publication
(10) Pub. No.: US 2012/0145549 A1
(43) Pub. Date: Jun. 14, 2012

(54) NANOSENSOR AND METHOD OF MANUFACTURING THE SAME

(75) Inventors: Seong-ho CHO, Gwacheon-si (KR); Dong-ho LEE, Seongnam-si (KR)

(73) Assignee: SAMSUNG ELECTRONICS CO., LTD., Suwon-si (KR)

(21) Appl. No.: 13/179,968

(22) Filed: Jul. 11, 2011

(30) Foreign Application Priority Data
Dec. 13, 2010 (KR) 10-2010-0127094

(51) Int. Cl. G01N 27/447; B32B 37/00; B05D 3/06; B05D 5/12

(52) U.S. Cl. 204/603; 427/122; 156/230; 427/552

(57) ABSTRACT

A nanosensor includes a substrate including a hole which extends through the substrate, a thin layer on the substrate and including a nanopore which is connected to the hole, and a first graphene layer and a second graphene layer which are on the thin layer and spaced apart from each other centering the nanopore therebetween. A method of manufacturing the nanosensor includes forming a nanopore in a thin layer on a substrate, and forming a first graphene layer and a second graphene layer on the thin layer. The first graphene layer and the second graphene layer are spaced apart from each other centering the nanopore therebetween.

### CROSS-REFERENCE TO RELATED APPLICATIONS

This application claims priority to Korean Patent Application No. 10-2010-0127094, filed on Dec. 13, 2010, and all the benefits accruing therefrom under 35 U.S.C. §119, the disclosure of which is incorporated herein in its entirety by reference.

### BACKGROUND

1. Field

Provided are nanosensors and methods of manufacturing the same, and more particularly, nanosensors capable of detecting a nucleic acid using nanopores and methods of manufacturing the nanosensors.

2. Description of the Related Art

Deoxyribonucleic acid (“DNA”) base sequences are determined using, for example, the Maxam-Gilbert method or the Sanger method. In the Maxam-Gilbert method, a DNA molecule having a target DNA base sequence is cut randomly with respect to a particular base into DNA molecules of different lengths and then the DNA molecules are separated by electrophoresis to determine the target DNA base sequence. In the Sanger method, a strand having a target DNA base sequence, DNA polymerase, a primer, normal deoxy nucleotide triphosphates (“dNTPs”), and dideoxy nucleotide triphosphates (“ddNTPs”) are put into a tube to synthesize strands having complementary DNA base sequences. When ddNTPs are added during the complementary DNA synthesis, the complementary DNA synthesis is terminated and strands having complementary DNA base sequences and different lengths may be obtained. By separating the strands having the complementary DNA base sequences by electrophoresis, the target DNA base sequence may be determined. However, DNA sequencing methods of the related art require great amounts of time and effort to determine base sequences. Thus, recently, research has been actively conducted on next-generation DNA sequencing methods of determining DNA base sequences using new techniques.

### SUMMARY

Provided are nanosensors capable of detecting a nucleic acid using nanopores and methods of manufacturing the nanosensors.

Additional aspects will be set forth in part in the description which follows and, in part, will be apparent from the description, or may be learned by practice of the presented embodiments.

Provided is a nanosensor including a substrate including a hole which extends through the substrate; a thin layer on the substrate and which includes a first nanopore connected to the hole; and a first graphene layer and a second graphene layer on the thin layer and spaced apart from each other centering the first nanopore therebetween.

A nanogap may be between the first graphene layer and the second graphene layer.

The first graphene layer and the second graphene layer may be symmetrical to each other with respect to the nanopore.

The first graphene layer and the second graphene layer may have a multi-layer structure including a plurality of stacked graphene sheets.

The thin layer may include an oxide or a nitride.

The thin layer may include one selected from the group consisting of SiN, SiO₂, Al₂O₃, TiO₂, BaTiO₃, and PbTiO₃.

The hole may be tapered from a bottom surface of the substrate to an upper surface of the substrate including the thin layer.

The nanosensor may further include a first electrode contact on the first graphene layer and a second electrode contact on the second graphene layer.

The nanosensor may further include an adhesive layer between the first graphene layer and the first electrode contact, and between the second graphene layer and the second electrode contact.

The nanosensor may further include an insulating layer on the first graphene layer and the second graphene layer.

The insulating layer may include a plurality of via holes which extends through the insulating layer. The nanosensor may further include a third electrode contact which is connected to the first graphene layer and a fourth electrode contact connected to the second graphene layer, via the plurality of via holes.

The insulating layer may include a second nanopore which is connected to the first nanopore.

The nanosensor may further include a housing which surrounds the nanosensor and which is divided into two areas with respect to the substrate.

The two areas may each include an electrode.

The nanosensor may further include water or an electrolyte solution which fills the housing.

According to another aspect of the present invention, a method of manufacturing a nanosensor includes: forming a thin layer on a substrate; forming a hole in the substrate; forming a nanopore connected to the hole, in the thin layer; and forming a first graphene layer and a second graphene layer on the thin layer. The first graphene layer and the second graphene layer are spaced apart centering the nanopore therebetween.

The forming the first graphene layer and the second graphene layer may include forming a graphene material layer on the thin layer and patterning the graphene material layer to form the first graphene layer and the second graphene layer, and a nanogap between the first and second graphene layers.

The forming the first graphene layer and the second graphene layer may include forming a graphene material layer on a support substrate, patterning the graphene material layer to form the first graphene layer and the second graphene layer, and transferring the formed first graphene layer and the second graphene layer from the support substrate onto the thin layer.

The first graphene layer and the second graphene layer may be formed by stacking a plurality of graphene sheets.

The nanopore may be formed by irradiating one selected from the group consisting of an electron beam, a focused ion beam, a neutral beam, a neutron beam, an X-ray, and a gamma ray (“γ-ray”).

The method may further include forming a first electrode contact on the first graphene layer and forming a second electrode contact on the second graphene layer.

The method may further include forming an insulating layer on the first graphene layer and the second graphene layer.

The method may further include forming a plurality of via holes in the insulating layer and filling the via holes with a conductive material to form a third electrode contact which is connected to the first graphene layer and a fourth electrode contact which is connected to the second graphene layer.

### BRIEF DESCRIPTION OF THE DRAWINGS

These and/or other aspects will become apparent and more readily appreciated from the following description of the embodiments, taken in conjunction with the accompanying drawings of which:

FIG. 1A is a plan view of a nanosensor according to an embodiment of the present invention;

FIG. 1B is a cross-sectional view of the nanosensor of FIG. 1A;

FIG. 1C is a cross-sectional view of the nanosensor of FIG. 1A surrounded by a housing;

FIG. 2A is a plan view of a nanosensor according to another embodiment of the present invention;

FIG. 2B is a cross-sectional view of the nanosensor of FIG. 2A; and

FIGS. 3A through 3G are cross-sectional views illustrating a method of manufacturing a nanosensor, according to an embodiment of the present invention.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

Various example embodiments will now be described more fully with reference to the accompanying drawings in which some example embodiments are shown.

Detailed illustrative example embodiments are disclosed herein. However, specific structural and functional details disclosed herein are merely representative for purposes of describing example embodiments. This invention may, however, be embodied in many alternate forms and should not be construed as limited to only the example embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element or layer is referred to as being “on” or “formed on” another element or layer, it can be directly or indirectly on or formed on the other element or layer. That is, for example, intervening elements or layers may be present. In contrast, when an element or layer is referred to as being “directly on” or “directly formed on” another element, there are no intervening elements or layers present. Other words used to describe the relationship between elements or layers should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an,” and “the” are intended to include the plural forms as well, unless the context clearly indicates otherwise. It will be further understood that the terms “comprises,” “comprising,” “includes,” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

In the drawings, the thicknesses of layers and regions are exaggerated for clarity. As used herein, connected may refer to elements being physically, fluidly and/or electrically connected to each other.

Hereinafter, the invention will be described in detail with reference to the accompanying drawings.

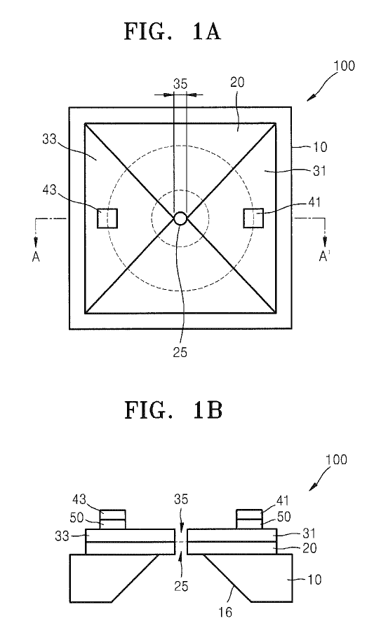

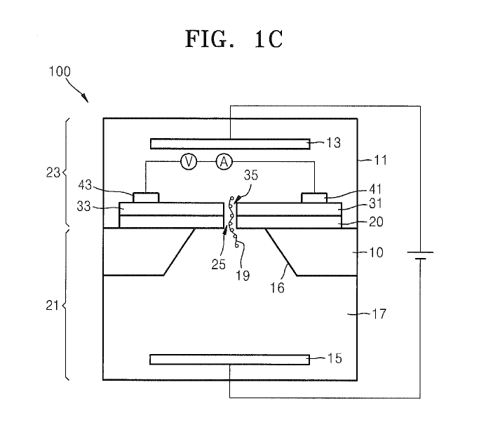

FIG. 1A is a plan view of a nanosensor 100 according to an embodiment of the present invention. FIG. 1B is a cross-sectional view of the nanosensor 100 taken along line A-A′ of FIG. 1A. FIG. 1C is a cross-sectional view of the nanosensor 100 surrounded by a housing 11.

Referring to FIGS. 1A and 1B, the nanosensor 100 may include a substrate 10 including a hole 16 extended therethrough, a thin layer 20 on the substrate 10 and that includes a nanopore 25 connected to the hole 16, and a first graphene layer 31 and a second graphene layer 33 that are spaced apart from each other centering the nanopore 25 therebetween. The nanosensor 100 may further include a first electrode contact 41 on the first graphene layer 31 and a second electrode contact 43 on the second graphene layer 33.

The substrate 10 supports the thin layer 20 and the first and second graphene layers 31 and 33 thereon, and may include, for example, a semiconductor material or a polymer material. Examples of the semiconductor material include, but are not limited to, Si, Ge, GaAs, InP, and GaN, and examples of the polymer material include, but are not limited to, an organic polymer and an inorganic polymer. Also, the substrate 10 may include, for example, quartz or glass.

The hole 16 which extends completely through a thickness of the substrate 10 may have a diameter taken in a direction parallel to an upper surface of the substrate 10 of several tens of micrometers (μm) or less. A diameter of the hole 16 may reduce in size in a direction taken upwardly from a bottom surface of the substrate 10 to an upper surface of the substrate 10 including the thin layer 20. In other words, the hole 16 may have a tapered structure narrowing from a lower portion to an upper portion of the substrate 10. Accordingly, the hole 16 having an inclined structure or inclined side surfaces may easily guide target molecules to flow from the lower portion of the substrate 10 into the nanopore 25. In an embodiment, the hole 16 may be formed by selective etching.

The thin layer 20 is on a portion of the substrate 10 to cover (e.g., overlap) a portion of the hole 16. The thin layer 20 may include a dielectric material or an insulating material. In one embodiment, for example, the thin layer 20 may include an oxide or a nitride, and more specifically, may include, for example, SiN, SiO₂, Al₂O₃, TiO₂, BaTiO₃, or PbTiO₃. The nanopore 25 which extends completely through a thickness of the thin layer 20 may be connected to the hole 16 of the substrate 10. That is, the nanopore 25 may be in a portion of the thin layer 20 corresponding to or aligned with the hole 16. The nanopore 25 may have a size corresponding to a size of a target molecule to be detected. The diameter of the nanopore 25 may be several nanometers (nm) to several tens of nm; for example, the diameter of the nanopore 25 may be about 1 nm to about 50 nm. The nanopore 25 may be formed by using, for example, an electron beam, a focused ion beam, a neutral beam, a neutron beam, an X-ray, or a gamma ray (“γ-ray”) emitted from a transmission electron microscope (“TEM”) or a scanning electron microscope (“SEM”), etc.

The first and second graphene layers 31 and 33 may be on the thin layer 20, and may be spaced apart from each other centering the nanopore 25 therebetween. The first and second graphene layers 31 and 33 may be symmetrical to each other with respect to the nanopore 25, and a nanogap 35 may be therebetween. The nanogap 35 may have a size equal to or less than about 100 nm, and equal to or greater than the diameter of the nanopore 25. As illustrated in FIG. 1A, the first and second graphene layers 31 and 33 may each be shaped as a polygon, such as a triangle, but the shape thereof is not limited thereto and may be various. Portions of the first and second graphene layers 31 and 33 that face each other may be sharp (e.g., having a thin edge or a fine point) in order to form the nanogap 35.

The first and second graphene layers 31 and 33 may be formed by patterning a graphene material layer on the thin layer 20. The graphene material layer may be formed on the thin layer 20 by performing, for example, a chemical vapor deposition (“CVD”) method, a mechanical or chemical exfoliation method, or an epitaxy growth method. Graphene is a conductive material in which carbon atoms are arranged in a honeycomb shape in two dimensions and that has a thickness corresponding to a thickness of an atomic layer, for example, about 0.34 nm. Graphene is structurally and chemically very stable, and is an excellent conductor having a charge mobility that is about 100 times greater than that of silicon, and can allow about 100 times more current to flow compared to copper. Thus, the first and second graphene layers 31 and 33 of the nanosensor 100 may each have a thickness of about 0.34 nm, and may have better electric conductivity than metal electrodes of the related art.

The first and second graphene layers 31 and 33 may include at least one graphene layer. That is, the first and second graphene layers 31 and 33 may each be a single graphene sheet or may be a multi-layer structure including a plurality of stacked graphene sheets. When the first and second graphene layers 31 and 33 are a multi-layer structure in which a plurality of graphene sheets are stacked, the thicknesses of the first and second graphene layers 31 and 33 may have a total thickness of about 0.34 nm.

The first electrode contact 41 may be on a portion of the first graphene layer 31, and a second electrode contact 43 may be on a portion of the second graphene layer 33. The first and second electrode contacts 41 and 43 may each include a conductive material. In one embodiment, for example, the first and second electrode contacts 41 and 43 may each include a metal such as Cu, Au, Ag, Pd, or Al. Electricity may be applied to the first and second graphene layers 31 and 33 from an outside through the first and second electrode contacts 41 and 43.

An adhesive layer 50 may be between the first electrode contact 41 and the first graphene layer 31, and between the second electrode contact 43 and the second graphene layer 33. The adhesive layer 50 provides an efficient contact between the first and second electrode contacts 41 and 43 and the first and second graphene layers 31 and 33, respectively, and may include a conductive material such as Ti, TiN, or Pd.

Referring to FIG. 1C, the nanosensor 100 may further include a housing 11 surrounding the nanosensor 100. The housing 11 may be divided into two areas with respect to the substrate 10. That is, the housing 11 may include a first area 21 below the substrate 10 and a second area 23 above the substrate 10. The first area 21 and the second area 23 may be connected via the nanopore 25. The first area 21 and the second area 23 may include an electrode 15 and an electrode 13, respectively. A voltage may be applied from an external power source to the electrodes 13 and 15. The electrode 15 in the first area 21 may be a negative (−) electrode, and the electrode 13 in the second area 23 may be a positive (+) electrode. The housing 11 may be filled with a buffer solution 17, and the buffer solution 17 may be water, deionized water, or an electrolyte solution. The buffer solution 17 may be a medium through which target molecules to be detected by the nanosensor 100 are moved.

Target molecules may flow from outside the housing 11 and/or the nanosensor 100 into the first area 21 below the substrate 10. Examples of the target molecules include, but are not limited to, nucleotides, nucleosides, single-stranded deoxyribonucleic acid (“DNA”) molecules, and double-stranded DNA molecules. Target molecules may also include ribonucleosides, ribonucleotides, single-stranded ribonucleic acid (“RNA”) molecules, and double-stranded RNA molecules. In FIG. 1C, a single-stranded DNA molecule 19 is illustrated as an example of a target molecule. The single-stranded DNA molecule 19 is negatively charged, and thus when an electric field is generated by a voltage applied to the electrodes 13 and 15, the single-stranded DNA molecule 19 may move from the first area 21, where the negative (−) electrode 15 is located, to the second area 23, where the positive (+) electrode 13 is located. That is, the single-stranded DNA molecule 19 flows from the first area 21 and moves toward the hole 16 of the substrate 10 due to the applied electric field, and is guided by the hole 16 to approach the nanopore 25. When the single-stranded DNA molecule 19 passes through the nanopore 25, it also passes through the nanogap 35 between the first and second graphene layers 31 and 33. Also, an electrical signal measuring unit such as an ammeter or a voltmeter may be connected to the first and second graphene layers 31 and 33 to measure variations in an electrical signal of the nanogap 35.

When a bias voltage is applied to the first and second graphene layers 31 and 33, variations in an electrical signal between the first and second graphene layers 31 and 33 when the single-stranded DNA molecule 19 passes trough the nanogap 35, that is, variations in a tunneling current, may be measured to distinguish bases of the single-stranded DNA molecule 19. That is, variations in a tunneling current between the nanogap 35 is measured as bases of the single-stranded DNA molecule 19 pass through the nanogap 35 to identify the bases. Metal electrodes have a thickness of several nm and thus are too thick to measure a base having a size of about 0.34 nm. However, the nanosensor 100 includes the first and second graphene layers 31 and 33 each having a thickness of about 0.34 nm, and thus have substantially the same thickness as the size of a base to the detected, which is about 0.34 nm. Accordingly, whether each of the bases of the single-stranded DNA molecule 19 passing through the nanogap 35 is adenine, guanine, cytosine, or thymine may be accurately distinguished.

In addition, the thickness of the first and second graphene layers 31 and 33 of the nanosensor 100 may be determined according to a size of target molecules by defining the number of graphene sheets of the first and second graphene layers 31 and 33 when each of the first and second graphene layers 31 and 33 includes a plurality of graphene sheets. Thus, target molecules having various sizes may be accurately distinguished. Moreover, as a next-generation DNA sequencing apparatus, the nanosensor 100 is capable of determining an order of DNA bases quickly and accurately, without needing to cut a single-stranded DNA molecule randomly and perform synthesis of complementary DNA molecules and then perform electrophoresis. Thus, costs may also be reduced.

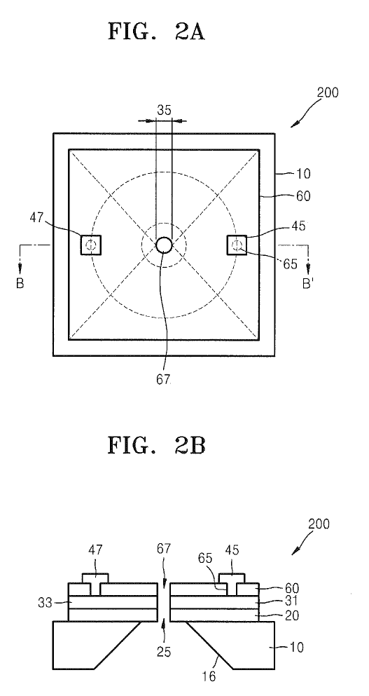

FIG. 2A is a plan view of a nanosensor 200 according to another embodiment of the present invention. FIG. 2B is a cross-sectional view of the nanosensor 200 taken alone line B-B′ of FIG. 2A. Descriptions will focus on differences from the previously described nanosensor 100 illustrated in FIGS. 1A through 1C.

Referring to FIGS. 2A and 2B, the nanosensor 200 may include the substrate 10 including the hole 16 extended therethrough, the thin layer 20 on the substrate 10 and that includes the nanopore 25 connected to the hole 16, and the first graphene layer 31 and the second graphene layer 33 that are spaced apart from each other centering the nanopore 25 therebetween. The nanosensor 200 may further include an insulating layer 60 on the first graphene layer 31 and the second graphene layer 33, and a third electrode contact 45 that is connected to the first graphene layer 31 and a fourth electrode contact 47 connected to the second graphene layer 33 via a plurality of via holes 65 in the insulating layer 60.

The insulating layer 60 may be on the first and second graphene layers 31 and 33 and a portion of the thin layer 20. The insulating layer 60 may include an insulating material, and the insulating material may be an oxide or a nitride. Examples of the insulating material include, but are not limited to, SiN, SiO₂, Al₂O₃, TiO₂, BaTiO₃, and PbTiO₃. Also, the insulating layer 60 may protect the first and second graphene layers 31 and 33 from outer elements, and may insulate the first and second graphene layers 31 and 33 from an external current. Also, the insulating layer 60 may reduce or effectively prevent a parasitic current. Accordingly, the nanosensor 200 is capable of measuring variations in an electrical signal of a nanogap 35 between the first and second graphene layers 31 and 33 in an environment in which noise from outside elements is reduced or effectively prevented, and thus is capable of distinguishing target molecules more accurately.

The insulating layer 60 may include a nanopore 67 and the plurality of via holes 65, each of which are extended completely through a thickness of the insulating layer 60. The nanopore 67 of the insulating layer 60 may be connected to the nanopore 25 of the thin layer 20 through the nanogap 35 which is between the nanopore 67 and the nanopore 25. Accordingly, a target molecule to be detected by the nanosensor 200 may sequentially pass through the nanopore 25 of the thin layer 20, the nanogap 35 between the first and second graphene layers 31 and 32, and the nanopore 67 of the insulating layer 60. The nanopore 67 may have a size corresponding to a size of a target molecule to be detected. A diameter of the nanopore 67 may be several to several tens of nm; for example, the diameter of the nanopore 67 may be about 1 nm to about 50 nm. Also, the diameter of the nanopore 67 may be the same as that of the nanopore 25. The plurality of via holes 65 of the insulating layer 60 exposes portions of the first and second graphene layers 31 and 33 which are under the insulating layer 60.

The third electrode contact 45 may be connected to the first graphene layer 31 through the one via hole 65 in the insulating layer 60 and on the first graphene layer 31, and the fourth electrode contact 47 may be connected to the second graphene layer 33 through the one via hole 65 in the insulating layer 60 and on the second graphene layer 33. The third electrode contact 45 may be formed by filling the via hole 65 overlapping the first graphene layer 31 with a conductive material, and the fourth electrode contact 47 may be formed by filling the via hole 65 overlapping the second graphene layer 33 with a conductive material. Examples of the conductive material may include, but are not limited to, metals such as Cu, Au, Ag, Pd, or Al. Electricity may be applied from the outside through the third and fourth electrode contacts 45 and 47 to the first and second graphene layers 31 and 33, respectively.

Hereinafter, a method of manufacturing the nanosensor 100 or 200 will be described in detail.

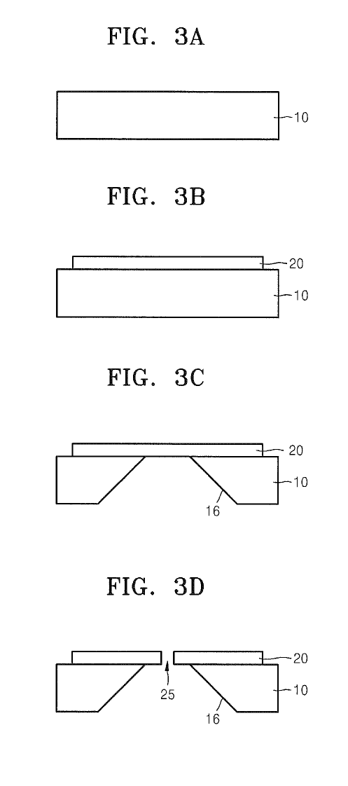

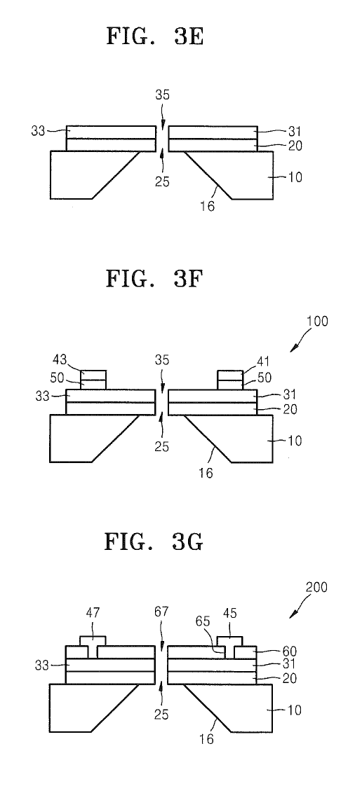

FIGS. 3A through 3G are cross-sectional views illustrating a method of manufacturing a nanosensor according to an embodiment of the present invention.

Referring to FIGS. 3A and 3B, a substrate 10 may be formed, and a thin layer 20 may be formed on the substrate 10. The substrate 10 may include a semiconductor material, a polymer material, or the like. Examples of the semiconductor material include, but are not limited to, Si, Ge, GaAs, InP, and GaN, and examples of the polymer material include, but are not limited to, an organic polymer and an inorganic polymer. In addition, the substrate 10 may include quartz, glass, or the like. The thin layer 20 may be coated or deposited on the substrate 10. The thin layer 20 may include an insulating material, and the insulating material may be an oxide or a nitride. Examples of the insulating material may include SiN, SiO₂, Al₂O₃, TiO₂, BaTiO₃, and PbTiO₃.

Referring to FIG. 3C, a hole 16 is formed in the substrate 10. The hole 16 may be formed by an etching operation; for example, when forming the hole 16 in a silicon substrate by using a wet etching operation, the hole 16 may be formed having an inclined structure by anisotropic etching according to a crystallization direction of silicon. The hole 16 may have a size of several tens of μm or less, and may be formed narrowing from a bottom surface of the substrate 10 to an upper surface of the substrate 10 on which the thin layer 20 is formed. That is, the hole 16 may be formed to have a tapered structure narrowing from a lower portion to an upper portion of the substrate 10, by selective etching.

Referring to FIG. 3D, a nanopore 25 is formed in the thin layer 20; the nanopore 25 is formed to be connected to the hole 16 of the substrate 10. The nanopore 25 may be formed in a portion of the thin layer 20 corresponding to the hole 16, by using, for example, an electron beam, a focused ion beam, a neutral beam, a neutron beam, an X-ray, or a γ-ray emitted from a TEM or an SEM, etc. The nanopore 25 may be formed to have a size corresponding to sizes of target molecules to be detected. In one embodiment, for example, a diameter of the nanopore 25 may be several to several tens of nm; in detail, the diameter of the nanopore 25 may be about 1 nm to about 50 nm.

Referring to FIG. 3E, first and second graphene layers 31 and 33 are formed on the thin layer 20. First, a graphene sheet may be formed on the thin layer 20 according to, for example, a CVD method, a mechanical or chemical exfoliation method, or an epitaxy growth method. Then, the graphene sheet may be patterned by using, for example, a lithography method to form the first and second graphene layers 31 and 33, and a nanogap 35 between the first and second graphene layers 31 and 33. Alternatively, the first and second graphene layers 31 and 33 may be formed separate from the thin layer 20 by forming a graphene sheet on a support substrate by using, for example, a CVD method, a mechanical and chemical exfoliation method, or an epitaxy growth method, and patterning the graphene sheet, thereby forming the first and second graphene layers 31 and 33, and the nanogap 35 between the first and second graphene layers 31 and 33. Also, the first and second graphene layers 31 and 33 may be separately formed and then transferred from the support substrate onto the thin layer 20. Here, the support substrate may be polydimethylsiloxane (“PDMS”) or polymethylmethacrylate (“PMMA”), or a thermal release tape may be used instead of the support substrate. Also, the CVD method, the mechanical or chemical exfoliation method, or the epitaxy growth method may be repeatedly performed on the thin layer 20 or the support substrate to stack a plurality of graphene sheets to form the first and second graphene layers 31 and 33.

Referring to FIG. 3F, a first electrode contact 41 is formed on a portion of the first graphene layer 31, and a second electrode contact 43 is formed on a portion of the second graphene layer 33. The first and second electrode contacts 41 and 43 may each include a conductive material; for example, the first and second electrode contacts 41 and 43 may each include a metal such as Cu, Au, Ag, Pd, or Al. Before forming the first and second electrode contacts 41 and 43, an adhesive layer 50 may be formed directly on portions of the first and second graphene layers 31 and 33, and the first and second electrode contacts 41 and 43 may be formed on the adhesive layer 50. The adhesive layer 50 may form an efficient contact between the first and second electrode contacts 41 and 43 and the first and second graphene layers 31 and 33, respectively, and may include a conductive material such as Ti, TiN, or Pd.

Referring to FIG. 3G, instead of performing the operation illustrated in FIG. 3F, an insulating layer 60 may be formed directly on the first and second graphene layers 31 and 33, and a portion of the thin layer 20. The insulating layer 60 may include an insulating material, and the insulating material may be an oxide or a nitride. Examples of the insulating material include, but are not limited to, SiN, SiO₂, Al₂O₃, TiO₂, BaTiO₃, and PbTiO₃. Also, a nanopore 67 and a plurality of via holes 65 may be formed in the insulating layer 60. The nanopore 67 of the insulating layer 60 may be formed in the same way that the nanopore 25 of the thin layer 20 is formed, and may be connected to the nanopore 25 of the thin layer 20 through the nanogap 35. Alternatively, the nanopore 67 of the insulating layer 60 may be formed at the same time as the nanopore 25 of the thin layer 20. That is, the nanopore 25 is not formed in advance in the thin layer 20 but the first and second graphene layers 31 and 33 and the insulating layer 60 are formed on the thin layer 20, and then the nanopores 25 and 67 may be respectively formed in the thin layer 20 and the insulating layer 60 at the same time.

In addition, the plurality of via holes 65 may be formed in the insulating layer 60 so as to expose portions of the first and second graphene layers 31 and 33 disposed under the insulating layer 60. The via holes 65 may be formed by using an etching operation. A third electrode contact 45 may be formed by filling the via hole 65 formed on the first graphene layer 31 with a conductive material, and a fourth electrode contact 47 may be formed by filling the via hole 65 formed on the second graphene layer 33 with a conductive material. Examples of the conductive material include, but are not limited to, metals such as Cu, Au, Ag, Pd, and Al.

In addition, referring to FIG. 1C, the method may further include forming the housing 11 to surround the nanosensor 100 or 200. The housing 11 may be divided into the first area 21 and the second area 23 with respect to the substrate 10. The electrode 15 and the electrode 13 may be formed in the first area 21 and the second area 23, respectively, and the housing 11 may be filled with the buffer solution 17. The buffer solution 17 may include, for example, water, deionized water, or an electrolyte solution.

It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. A nanosensor comprising:
a substrate including a hole which extends through the substrate;
a thin layer on the substrate and including a first nanopore which is connected to the hole; and
a first graphene layer and a second graphene layer on the thin layer and spaced apart from each other centering the first nanopore therebetween.

2. The nanosensor of claim 1, wherein the spaced first graphene layer and second graphene layer define a nanogap therebetween.

3. The nanosensor of claim 1, wherein the first graphene layer and the second graphene layer are symmetrical to each other with respect to the first nanopore.

4. The nanosensor of claim 1, wherein the first graphene layer and the second graphene layer have a multi-layer structure including a plurality of stacked graphene sheets.

5. The nanosensor of claim 1, wherein the thin layer includes an oxide or a nitride.

6. The nanosensor of claim 1, wherein the thin layer includes one selected from the group consisting of SiN, SiO₂, Al₂O₃, TiO₂, BaTiO₃, and PbTiO₃.

7. The nanosensor of claim 1, wherein the hole tapers from a bottom surface of the substrate to an upper surface of the substrate the thin layer on the upper surface of the substrate.

8. The nanosensor of claim 1, further comprising a first electrode contact on the first graphene layer and a second electrode contact on the second graphene layer.

9. The nanosensor of claim 8, further comprising an adhesive layer between the first graphene layer and the first electrode contact, and between the second graphene layer and the second electrode contact.

10. The nanosensor of claim 1, further comprising an insulating layer on the first graphene layer and the second graphene layer.

11. The nanosensor of claim 10,
wherein the insulating layer comprises a plurality of via holes which extends through the insulating layer, and
further comprising a third electrode contact connected to the first graphene layer and a fourth electrode contact connected to the second graphene layer, via the plurality of via holes in the insulating layer.

12. The nanosensor of claim 10, wherein the insulating layer comprises an second nanopore which is connected to the first nanopore.

13. The nanosensor of claim 1, further comprising a housing which surrounds the nanosensor and which is divided into two areas with respect to the substrate.

14. The nanosensor of claim 13, wherein the two areas each include an electrode.

15. The nanosensor of claim 13, further comprising water or an electrolyte solution which fills the housing.

16. A method of manufacturing a nanosensor, the method comprising:
forming a thin layer on a substrate;
forming a hole in the substrate;
forming a nanopore connected to the hole, in the thin layer; and
forming a first graphene layer and a second graphene layer on the thin layer, wherein the first graphene layer and the second graphene layer are spaced apart centering the nanopore therebetween.

17. The method of claim 16, wherein the forming the first graphene layer and the second graphene layer comprises:
forming a graphene material layer on the thin layer, and
patterning the graphene material layer to form the first graphene layer and the second graphene layer, and a nanogap between the first and second graphene layers.

18. The method of claim 16, wherein the forming the first graphene layer and the second graphene layer comprises:
forming a graphene material layer on a support substrate,
patterning the graphene material layer to form the first graphene layer and the second graphene layer, and
transferring the formed first graphene layer and the second graphene layer from the support substrate onto the thin layer.

19. The method of claim 16, wherein the first graphene layer and the second graphene layer are formed by stacking a plurality of graphene sheets.

20. The method of claim 16, wherein the nanopore is formed by irradiating one selected from the group consisting of an electron beam, a focused ion beam, a neutral beam, a neutron beam, an X-ray, and a gamma ray (γ-ray).

21. The method of claim 16, further comprising forming a first electrode contact on the first graphene layer and forming a second electrode contact on the second graphene layer.

22. The method of claim 16, further comprising forming an insulating layer on the first graphene layer and the second graphene layer.

23. The method of claim 22, further comprising:
forming a plurality of via holes in the insulating layer, and
filling the via holes with a conductive material to form a third electrode contact which is connected to the first graphene layer and a fourth electrode contact which is connected to the second graphene layer.

24. A nanosensor comprising:
a substrate comprising a first hole which extends through the substrate and through which a nucleic acid molecule including a base sequence enters the nanosensor;
an insulating layer comprising a second hole which is in fluid connection with the first hole and through which the nucleic acid molecule passes; and
a first graphene layer and a second graphene layer which are spaced apart from each other with respect to the first and second holes, a nanogap defined between the first graphene layer and the second graphene layer and in fluid connection with the first and second holes,
wherein
the insulating layer is between the substrate and the first graphene layer, and between the substrate and the second graphene layer, and
a thickness of the first graphene layer and the second graphene layer are substantially similar to a size of the base sequence of the nucleic acid molecule.

25. The nanosensor of claim 1, wherein the thickness of the first graphene layer and the second graphene layer is less than 0.5 nanometer.

26. The nanosensor of claim 1, further comprising:
a first electrode contact in electrical connection with the first graphene layer, and
a second electrode contact in electrical connection with the second graphene layer.
